(19) United States
(12) Patent Application Publication
(10) Pub. No.: US 2026/0291071 A1
(43) Pub. Date: Sep. 24, 2026

(54) PATCH RADIATING ELEMENT AND BASE STATION ANTENNA

(71) Applicant: Outdoor Wireless Networks LLC, Richardson, TX (US)

(72) Inventors: Cheng Xue, Suzhou (CN); Changfu Chen, Suzhou (CN); Ligang Wu, Suzhou (CN); Bin Sun, Suzhou (CN); Jian Zhang, Suzhou (CN); YueMin Li, Suzhou (CN)

(21) Appl. No.: 19/570,438

(22) Filed: Mar. 18, 2026

(30) Foreign Application Priority Data
Mar. 24, 2025 (CN) 202510352093.2

(51) Int. Cl. H01Q 9/04; H01Q 1/24; H01Q 15/24; H01Q 21/06

(52) U.S. Cl. CPC H01Q 9/045; H01Q 1/246; H01Q 15/24; H01Q 21/065

(57) ABSTRACT

A patch radiating element includes a feeder pillar and a patch radiator positioned at a front end of the feeder pillar. The patch radiator includes a plurality of slots that are configured such that when the patch radiator is fed an RF signal via the feeder pillar, the current in a central area of the patch radiator is increased as compared to when the patch radiator does not include the plurality of slots.

### CROSS-REFERENCE TO RELATED APPLICATION

The present application claims priority to Chinese Patent Application No. 202510352093.2, filed Mar. 24, 2025, the entire content of which is incorporated herein by reference as if set forth fully herein.

### FIELD

The present disclosure generally relates to the field of radio communication, and more specifically, to a patch radiating element and a base station antenna.

### BACKGROUND

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with mobile subscribers that are within the cell served by the base station.

In many cases, each base station is divided into “sectors”. In perhaps the most common configuration, a hexagonally shaped cell is divided into three 120° sectors, and each sector is served by one or more base station antennas that have an azimuth Half Power Beam Width (HPBW) of approximately 65°. Typically, the base station antennas are mounted on a tower, with the radiation patterns that are generated by the base station antennas directed outwardly. Base station antennas typically include one or more linear and/or planar phased arrays of radiating elements.

Patch radiating elements are attracting more and more attention because of their advantages such as low height, light weight, low cost, and high polarization purity. A multi-column array of patch radiating elements may be used, for example, in a beam-forming antenna or to support large-scale multi-input multi-output (MIMO) communications.

### SUMMARY

According to an aspect of the present disclosure, a patch radiating element is provided, including: a feeder pillar; and a patch radiator positioned at a front end of the feeder pillar, the patch radiator including a plurality of slots, where the plurality of slots are configured such that when the patch radiator is fed a radio frequency (“RF”) signal via the feeder pillar, the current in a central area of the patch radiator is increased as compared to when the patch radiator does not include the plurality of slots.

In some embodiments, the patch radiator includes first and second feed points for a first polarized RF signal and third and fourth feed points for a second polarized RF signal, where the plurality of slots are configured such that: a current flowing along a first feed direction is generated in the central area of the patch radiator when the patch radiator is fed an RF signal via the first and second feed points, the first feed direction being defined by the first and second feed points; or a current flowing along a second feed direction is generated in the central area of the patch radiator when the patch radiator is fed an RF signal via the third and fourth feed points, the second feed direction being defined by the third and fourth feed points.

In some embodiments, each of the plurality of slots has one or more geometric lengths, where: a maximum geometric length of the one or more geometric lengths is between 0.1 and 0.5 times the operating wavelength of the patch radiator; or the one or more geometric lengths are each between 0.1 and 0.5 times the operating wavelength of the patch radiator.

In some embodiments, each of the plurality of slots has one or more branches.

In some embodiments, each of the plurality of slots extends from a first position on the patch radiator to a second position on the patch radiator, the first position being adjacent a respective edge of the patch radiator, the second position being adjacent a center of the patch radiator.

In some embodiments, each of the plurality of slots is symmetrical with respect to a respective axis passing through the center of the patch radiator and perpendicular to the respective edge of the patch radiator.

In some embodiments, each of the plurality of slots includes a first slot portion that extends along a respective axis that passes through the center of the patch radiator and is perpendicular to the respective edge of the patch radiator. In some embodiments, each of the plurality of slots includes a second slot portion extending at an angle to the respective axis and connected with the first slot portion. In some embodiments, the second slot portion is perpendicular to the respective axis and is closer to the respective edge of the patch radiator than a center of the patch radiator.

In some embodiments, each of the plurality of slots includes a first slot portion located on a first side of a respective axis that passes through the center of the patch radiator and perpendicular to the respective edge of the patch radiator and a second slot portion located on a second side of the respective axis that is opposite the first side, the second slot portion being connected with the first slot portion.

In some embodiments, each of the plurality of slots includes a plurality of slot portions that are not connected to one another, each of the plurality of slot portions extending from a respective first position on the patch radiator to a respective second position on the patch radiator, the respective first position being adjacent a respective edge of the patch radiator, and the respective second position being adjacent a center of the patch radiator. In some embodiments, each of the plurality of slot portions has one or more geometric lengths, at least a maximum geometric length of the one or more geometric lengths being between 0.1 and 0.5 times the operating wavelength of the patch radiator. In some embodiments, the plurality of slot portions have different geometric lengths from one another. In some embodiments, each of the plurality of slot portions has one or more branches. In some embodiments, each slot portion of the plurality of slot portions is symmetrical with respect to a respective axis passing through the center of the patch radiator and perpendicular to the respective edge of the patch radiator. In some embodiments, the plurality of slot portions as a whole have axial symmetry with respect to the respective axis. In some embodiments, each slot portion of the plurality of slot portions includes a first segment located on a first side of the respective axis and a second segment located on a second side of the respective axis opposite the first side, the second segment being connected with the first segment. In some embodiments, the plurality of slot portions includes a first slot portion located on a first side of the respective axis and a second slot portion located on a second side opposite the first side of the respective axis, the second slot portion being not connected with the first slot portion.

In some embodiments, each of the plurality of slots is symmetrical with a first adjacent slot with respect to the first direction of feed and is symmetrical with a second adjacent slot with respect to the second direction of feed.

In some embodiments, the plurality of slots generally have rotational symmetry with respect to a center of the patch radiator.

In some embodiments, the patch radiating element is a multi-piece radiating element, and the patch radiator is mounted on a front end of the feeder pillar. In some embodiments, the patch radiating element is a one-piece radiating element and the feeder pillar is cut and bent from a metal sheet forming the patch radiator.

In some embodiments, the patch radiator comprises a first patch portion and a second patch portion positioned at an edge of the first patch portion and extending rearwardly from the first patch portion, where the plurality of slots are disposed on the first patch portion.

According to another aspect of the present disclosure, a patch radiating element is provided, including: a feeder pillar; and a patch radiator positioned at a front end of the feeder pillar, a slot disposed on the patch radiator, the slot extending from a first position on the patch radiator to a second position on the patch radiator, the first position being adjacent an edge of the patch radiator, the second position being adjacent a center of the patch radiator.

In some embodiments, the slot has one or more geometric lengths, where: a maximum geometric length of the one or more geometric lengths is between 0.1 and 0.5 times the operating wavelength of the patch radiator; or the one or more geometric lengths are each between 0.1 and 0.5 times the operating wavelength of the patch radiator.

In some embodiments, the slot has one or more branches.

In some embodiments, the slot is symmetrical with respect to an axis passing through the center of the patch radiator and perpendicular to the edge of the patch radiator.

In some embodiments, the slot includes a first slot portion extending along an axis that passes through the center of the patch radiator and is perpendicular to the edge of the patch radiator. In some embodiments, the slot includes a second slot portion that extends at an angle to the axis and is connected with the first slot portion.

In some embodiments, the slot includes a first slot portion located on a first side of an axis that passes through the center of the patch radiator and perpendicular to the edge of the patch radiator and a second slot portion located on a second side of the axis opposite the first side, the second slot portion being connected with the first slot portion.

In some embodiments, the slot includes a plurality of slot portions that are not connected to one another, each slot portion of the plurality of slot portions extending from a respective first position on the patch radiator to a respective second position on the patch radiator, the respective first position being adjacent the edge of the patch radiator, the respective second position being adjacent the center of the patch radiator. In some embodiments, each of the plurality of slot portions has one or more geometric lengths, at least a maximum geometric length of the one or more geometric lengths being between 0.1 and 0.5 times the operating wavelength of the patch radiator. In some embodiments, the plurality of slot portions have different geometric lengths from one another. In some embodiments, each of the plurality of slot portions has one or more branches. In some embodiments, each slot portion of the plurality of slot portions is symmetrical with respect to an axis passing through the center of the patch radiator and perpendicular to the edge of the patch radiator. In some embodiments, the plurality of slot portions as a whole have axial symmetry with respect to the axis. In some embodiments, each slot portion of the plurality of slot portions includes a first segment located on a first side of the axis and a second segment located on a second side of the axis opposite the first side, the second segment being connected with the first segment. In some embodiments, the plurality of slot portions include a first slot portion located on a first side of the axis and a second slot portion located on a second side of the axis opposite the first side, the second slot portion being not connected with the first slot portion.

In some embodiments, a plurality of the slots are disposed on the patch radiator, the plurality of the slots as a whole having rotational symmetry with respect to the center of the patch radiator.

According to yet another aspect of the present disclosure, a base station antenna is provided, including: a reflector; and a radiating element mounted on and extending forward from the reflector, where the radiating element is a patch radiating element according to any embodiment of the above aspects of the present disclosure.

In some embodiments, the base station antenna includes an array of a plurality of the radiating elements and the base station antenna further includes: a plurality of fences mounted on and extending forward from the reflector, each arranged in a first direction parallel to a column in the array such that each column of the array is located between adjacent two fences of the plurality of fences, where each of the plurality of fences includes a plurality of metal portions arranged spaced apart from one another along the first direction.

In some embodiments, each fence includes a printed circuit board, the plurality of metal portions are formed of metal deposited on the printed circuit board, and the printed circuit board have no metal at a gap between each adjacent two metal portions of the plurality of metal portions.

In some embodiments, each fence includes a plurality of metal sheets arranged spaced apart from each other along the first direction, each metal portion of the plurality of metal portions being formed by a respective one of the plurality of metal sheets.

In some embodiments, each radiating element overlaps a gap between a respective two of the plurality of metal portions of each of the plurality of fences, seen in a second direction parallel to the rows in the array.

Through the following detailed description of exemplary examples of the present disclosure by referencing the attached drawings, other features and advantages of the present disclosure will become clearer.

### BRIEF DESCRIPTION OF THE DRAWING

FIG. 1 is a schematic bottom view of a patch radiating element according to some examples of the present disclosure.

FIG. 2 is a schematic perspective view of a patch radiating element according to some examples of the present disclosure.

FIG. 3 is a schematic perspective view of a patch radiating element according to some other examples of the present disclosure.

FIG. 4 are schematic front views of two patch radiating elements that depict current distributions on patch radiators thereof when the patch radiating element shown in FIG. 2 and a patch radiating element without a slot are fed respective RF signals.

FIG. 5 is a schematic front view of the patch radiating element shown in FIG. 2.

FIG. 6 schematically depicts one of the slots in the patch radiator of the patch radiating element shown in FIG. 2.

FIGS. 7-11 schematically depict a variety of example slot designs for patch radiating elements, respectively, according to some examples of the present disclosure.

FIG. 12 is a schematic perspective and bottom view of a patch radiating element, consistent with some examples of the present disclosure.

FIG. 13 is a schematic perspective and bottom view of a patch radiating element, consistent with some examples of the present disclosure.

FIG. 14 is a schematic perspective view of a base station antenna according to some examples of the present disclosure.

FIGS. 15 and 16 are schematic perspective views of two example fences that may be applied in a base station antenna, consistent with some examples of the present disclosure.

FIG. 17 is a schematic perspective view of a single patch radiating element and further includes graphs that show the Return Loss (RL) and Isolation Performance (Isolation) of the single patch radiating element when implemented both with and without a slot.

FIG. 18 is a schematic perspective view of an array of patch radiating elements along with graphs that compare the cross-polarization ratios (CPRs) of the array when the patch radiating elements have, and do not have, slots.

It should be noted that in the examples described below, the same reference signs are sometimes used across different attached drawings to denote the same parts or parts with similar functions, and repeated descriptions thereof are omitted. In some cases, similar mark numbers and letters are used to denote similar items. Therefore, once a certain item is defined in one attached drawing, there is no need for further discussion in subsequent attached drawings.

For ease of understanding, the position, dimension, and range of each structure shown in the attached drawings and the like sometimes do not represent the actual position, dimension, and range. Therefore, the present disclosure is not limited to the positions, dimensions, and ranges disclosed in the attached drawings and the like

### DETAILED DESCRIPTION

Various exemplary examples of the present disclosure will be described in detail below by referencing the attached drawings. It should be noted that: unless otherwise specifically stated, the relative arrangement, numerical expressions and numerical values of components and steps set forth in these examples do not limit the scope of the present disclosure.

The following description of at least one exemplary example is actually only illustrative, and in no way serves as any limitation to the present disclosure and its application or use. In other words, the structure and method herein are shown in an exemplary manner to illustrate different examples of the structure and method in the present disclosure. However, those skilled in the art will understand that they only illustrate exemplary ways of implementing the present disclosure, rather than exhaustive ways. In addition, the attached drawings are not necessarily drawn to scale, and some features may be enlarged to show details of specific components.

In addition, the technologies, methods, and equipment known to those skilled in the art may not be discussed in detail, but where appropriate, the technologies, methods, and equipment should be regarded as part of the Specification.

In all examples shown and discussed herein, any specific value should be construed as merely exemplary value and not as limiting value. Therefore, other examples of the exemplary example may have different values.

The base station antennas according to various examples of the present disclosure will be elaborated below with reference to the attached drawings. It should be understood that the actual base station antenna may further comprise other components, but to avoid obscuring the key elements of the present disclosure, they will not be discussed herein, and these other components will also not be shown in the attached drawings. It will be understood that since antennas are typically vertically installed, the description herein that one element is positioned in front of another element is performed in the case that the antenna is seen from the front.

It will be understood that the radiating elements and base station antennas are shown in the figures with the radiating element extending upwardly (e.g., from a reflector). In use, the base station antenna is rotated 90° such that the radiating element is positioned to extend forwardly from the reflector. The following description will describe the relative positioning of the components of the base station antenna as if the base station antenna were mounted for use even though the base station antenna is rotated 90° relative to the orientation in the figures.

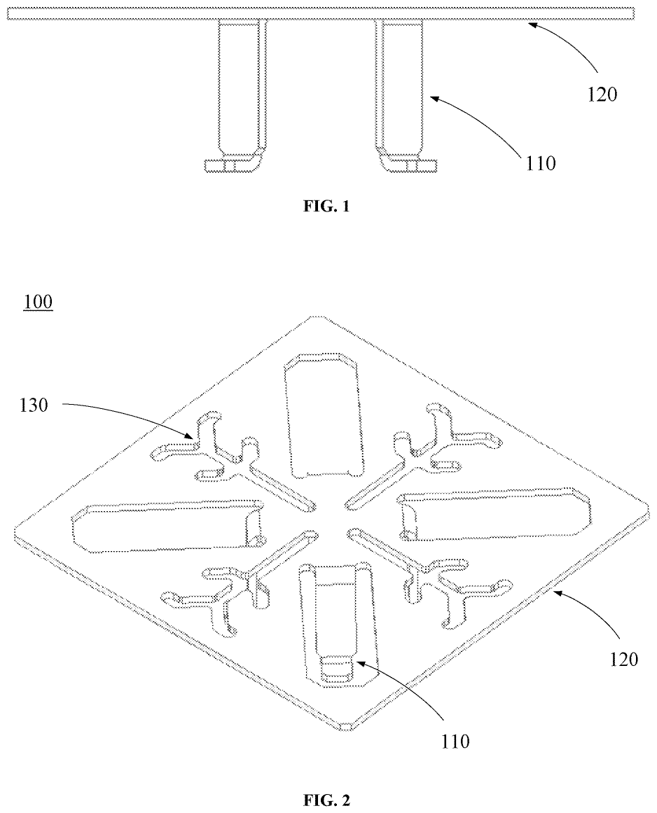

FIG. 1 is a schematic bottom view of a patch radiating element 100, according to some examples of the present disclosure.

As shown in FIG. 1, the patch radiating element 100 may include a plurality of feeder pillars 110 and the patch radiator 120 mounted on the feeder pillars 110. The feeder pillars 110 may extend forward from a feed board (not shown) and be mechanically and electrically connected to the patch radiator 120 at a front end portion of the feeder pillar 110 so as to feed an RF signal to the patch radiator 120.

In order to meet requirements for frequency bandwidth and return loss (for example, 15 dB or higher) for modern base station antennas, the patch radiating element 100 may be configured as an air dielectric patch radiating element. In addition, the patch radiating element 100 may be designed as a dual-polarized patch radiating element. Such a dual-polarized patch radiating element can include a first and a second feed point for a first polarization RF signal, and a third and fourth feed point for a second polarization RF signal. For example, as shown in FIG. 4 as described later, the patch radiating element 100 may include a first pair of feeder pillars 110 that are fed and a second pair of feeder pillars 110 that are arranged intersecting the first pair of feeder pillars 110. A first pair of feeder pillars 110 may be configured to feed a RF signal from a first polarization port to the patch radiator 120 and may be electrically connected with a first feed point and a second feed point, respectively, while a second pair of feeder pillars 110 may be configured to feed the patch radiator 120 with an RF signal from a second polarization port and may be electrically connected with a third feed point and a fourth feed point, respectively. In still other examples, the patch radiating element 100 may also include two feeder pillars 110 one of which is configured to feed the patch radiator 120 with RF signals from the first polarization port and may be electrically coupled with both the first and second feed points, while the other feeder pillar 110 is configured to feed the patch radiator 120 with RF signals from the second polarization port and may be electrically coupled with both the third and fourth feed points. No particular limits are made herein to the specific number and configuration of the feeder pillars 110.

In some examples, the patch radiating element 100 is a one piece radiating element in which the feeder pillars 110 and the patch radiator 120 comprise a single monolithic element. For example, the feeder pillars 110 may be cut-outs from the patch radiator 120 that are bent rearwardly. Such a design simplifies processing and provides a more integrated structure. For example, as shown in FIG. 2, the four feeder pillars 110 are integrally formed with the patch radiator 120 and are curved rearwardly from the sheet of metal forming the patch radiator 120, so that each of the feeder pillars 110 may provide a respective of the first to fourth feed points at the locations where the feeder pillars 110 start to bend rearwardly from the patch radiator 120.

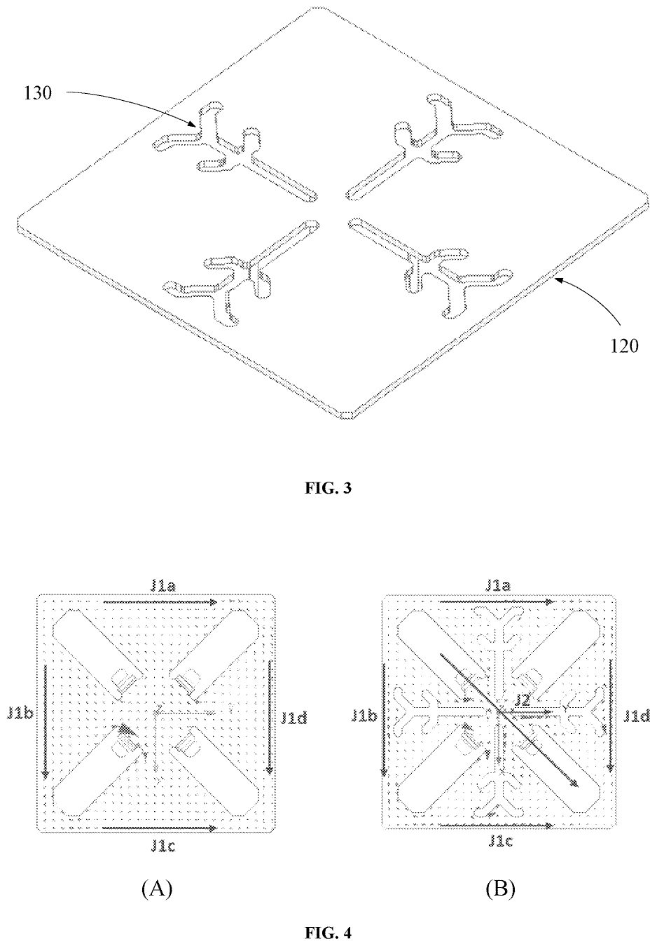

In still further examples, the patch radiating element 100 may be a multi-piece structure and the patch radiator 120 may be mounted (e.g., welded) on the front end of a plurality of feeder pillars 110. Such a design may be advantageous in the context of the present disclosure. For example, as shown in FIG. 3, since it is not necessary to cut the feeder pillar 110 from the metal sheet forming the patch radiator 120, the patch radiator 120 has sufficient surface area to flexibly design and arrange the slots that are described in further detail later herein. In this document, for ease of illustration and not limitation, patch radiating elements will be illustrated primarily as a one-piece patch radiating element 100 as shown in FIG. and shown in a front view to easily identify the direction of the feed.

Referring to FIG. 2, the patch radiating element 100 also includes a slot 130 in the patch radiator 120. Such a slot 130 may serve as an additional resonant structure that enables the patch radiating element 100 to achieve a wider operating bandwidth. FIG. 2 depicts four slots in the patch radiator 120, each slot having a “human” like shape. It will be understood that this is merely exemplary and non-limiting in that the number and shape of the slots 130 may be configured in a specific manner depending on the situation and various example configurations of the slots 130 will be described later herein. It will also be understood that although the figures depict the patch radiators as having a square profile, this is merely exemplary and not limiting, the disclosure may be applied to the patch radiators having various shaped profiles.

The slots 130 may be configured such that when the patch radiator 120 is fed an RF signal via the feeder pillars 110, the current in the central area of the patch radiator 120 is increased as compared to when the patch radiator 120 does not include any slots 130. Specifically, referring to FIG. 4, the distribution of current in the patch radiator 120 is shown when RF signals are fed via the illustrated upper left and lower right feeder pillars 110, wherein the deeper the color of the point indicates the greater the current density at that point. In FIG. 4, (A) shows the current simulation result for the patch radiator 120 without the slot 130 and (B) shows the current simulation result for the patch radiator 120 with the slot 130 included. It can be seen that when the slots 130 are omitted, the current is distributed substantially in the edge area of the patch radiator 120 (e.g., J1a, J1b, J1c, J1d, which may establish a resonant mode depending on the size of the patch radiator 120), while there is little current in the central area of the patch radiator 120 (not able to produce a sufficiently strong resonator). In the case when the slots 130 are provided, a strong current is present in the central area of the patch radiator 120 (e.g., J2, a new resonant mode may be established depending on the size of the slots 130), thereby becoming more likely to be stimulated, which facilitates matching. Each slot 130 may incentivize two current paths at the working frequency band proximate both sides thereof, directing current from the edge region to the central region to facilitate impedance matching and radiation properties of the patch radiating element 100.

In some examples, when the patch radiating element 100 is fed an RF signal via a first feed point and a second feed point, current flowing along a first feed direction may be generated in a central area of the patch radiator 120, defined by the first and second feed points; when the patch radiator 120 is fed RF signals via a third and fourth feed points, the third feed point may be generated along the third feed direction. For example, in FIG. 4, (B) new current J2 flowing along the direction of feed (in this example, along a diagonal direction defined by the left upper and right lower feeder pillars) is generated in a central area of the patch radiator 120 as compared to (A). In addition, J1a, J1b, J1c, J1d were enhanced to become more likely to be stimulated, which is also beneficial for matching.

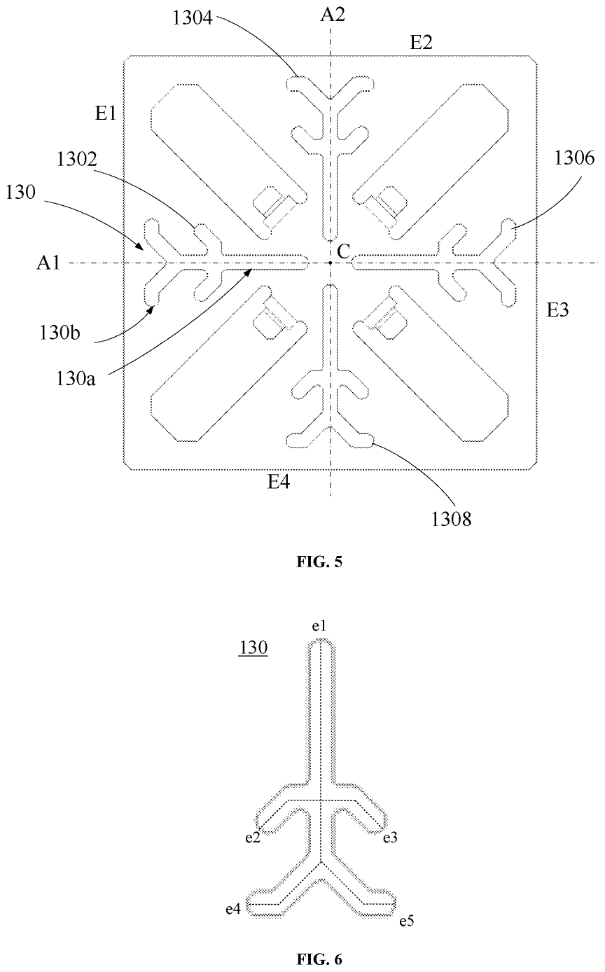

The slot 130 may be configured to extend from a first position on the patch radiator 120 to a second position on the patch radiator 120 adjacent an edge of the patch radiator 120, which is adjacent a center of the patch radiator 120. In this way, a current may be directed from the edge region to the central region to facilitate impedance matching and radiation performance of the patch radiating element 100. For example, referring to FIG. 5, an elevational view of the patch radiating element 100 shown in FIG. 2 is shown. In such an example, a plurality of slots 1302, 1304, 1306, 1308 (which may also be collectively referred to as slots 130) are provided on the patch radiator 120, each slot extending from a location adjacent a respective edge of the patch radiator 120 to a location adjacent a center of the patch radiator 120. Specifically, the slot 1302 extends from a position adjacent the edge E1 of the patch radiator 120 to a position adjacent the center C of the patch radiator 120, the slot 1304 extends from a position adjacent the edge E2 of the patch radiator 120 to a position adjacent the center C of the patch radiator 120, the slot 1306 extends from a position adjacent the edge E3 of the patch radiator 120 to a position adjacent the center C of the patch radiator 120, and slot 1308 extends from a position adjacent the edge E4 of the patch radiator 120 to a position adjacent center C of the patch radiator 120.

Each slot 130 may have one or more geometric lengths, thereby having one or more resonating lengths. In some examples, each slot 130 may be configured to have one or more branches. These branches may cause the slot 130 to have a plurality of different geometric lengths. A plurality of different resonant lengths may be used to increase the resonant bandwidth. For example, referring to FIG. 6, a slot 130 is shown that has multiple branches and may provide for multiple different geometric lengths, e.g., including a first geometric length from e1 to e2 or e3 along the illustrated, a second geometric length from e1 to e4 or e5 along the illustrated, a third geometric length from e2 to e3 along the illustrated, a fourth geometric length from e4 to e5 along the illustrated, and a fifth geometric length from e2 or e3 to e4 or e5 along the illustrated, broken line. In addition, these branches may also be used to fine-tune impedance matching to increase matching bandwidth and decrease Q values.

The geometric length of the slot 130, especially the maximum geometric length of the plurality of geometric lengths, affects the impedance matching performance. In some examples, the slot 130 may be configured such that the maximum geometric length of the slot 130 is between 0.1 and 0.5 times the operating wavelength of the patch radiator 120. For example, referring to FIG. 6, the second geometric length is the maximum geometric length, and when it is between 0.1 and 0.5 times the operating wavelength of the patch radiator 120, the patch radiating element 100 will have good impedance matching performance, thereby increasing the impedance operating bandwidth. In some examples, the slot 130 may be configured such that all geometric lengths of the slot 130 are between 0.1 to 0.5 times the operating wavelength of the patch radiator 120. Additionally, the width of the slot 130 is not specifically limited herein.

Referring back to FIG. 5, in some examples, the slots 130 may be symmetrical with respect to a respective axis that passes through the center of the patch radiator 120 and perpendicular to a respective edge of the patch radiator 120. Such symmetry may facilitate both transmission and reception or RF signals at the respective first and second polarizations for the dual-polarized patch radiating element 100. Specifically, the slots 1302 and 1306 are each symmetrical with respect to the center C passing through the patch radiator 120 and perpendicular to the respective edges E1, axis A1 of E3 of the patch radiator 120, and the slots 1304 and 1308 are each symmetrical with respect to the center C passing through the patch radiator 120 and perpendicular to the respective edges E2, axis A2 of E4 of the patch radiator 120.

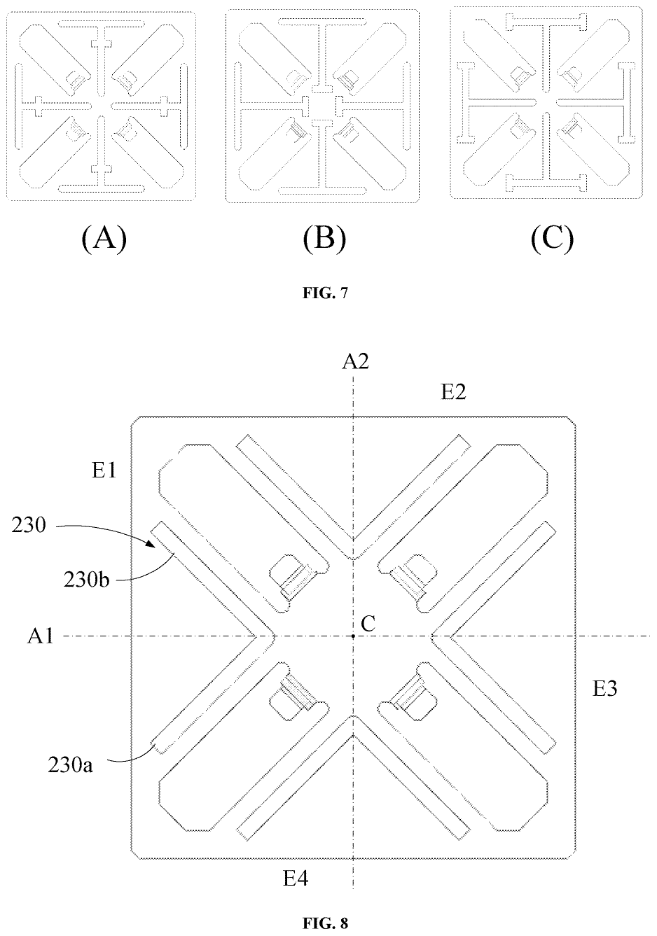

In some examples, the slot 130 includes a first slot portion that extends along a respective axis. Additionally, in some examples, the slot 130 includes a second slot portion that extends at an angle (e.g., but not limited to, vertically) with a respective axis and is in connection with the first slot portion. In some examples, the second slot portion is closer to a respective edge of the patch radiator 120 than the center of the patch radiator 120. For example, in the example of FIG. 5, the slot 130 includes a first slot portion 130a extending along axis A1 (A2) and a plurality of second slot portions 130b extending at an angle to axis A1 (A2) and in connection with the first slot portion 130a. FIG. 7 further illustrates a variety of different example configurations having a first slot portion extending along a respective axis and a slot of a second slot portion extending perpendicularly to the respective axis and coupled with the first slot portion, wherein the slot in (A) has a small branch at an intermediate position between a respective edge and center, and the slot in (B) has a small branch at a location proximate to the edge, (C).

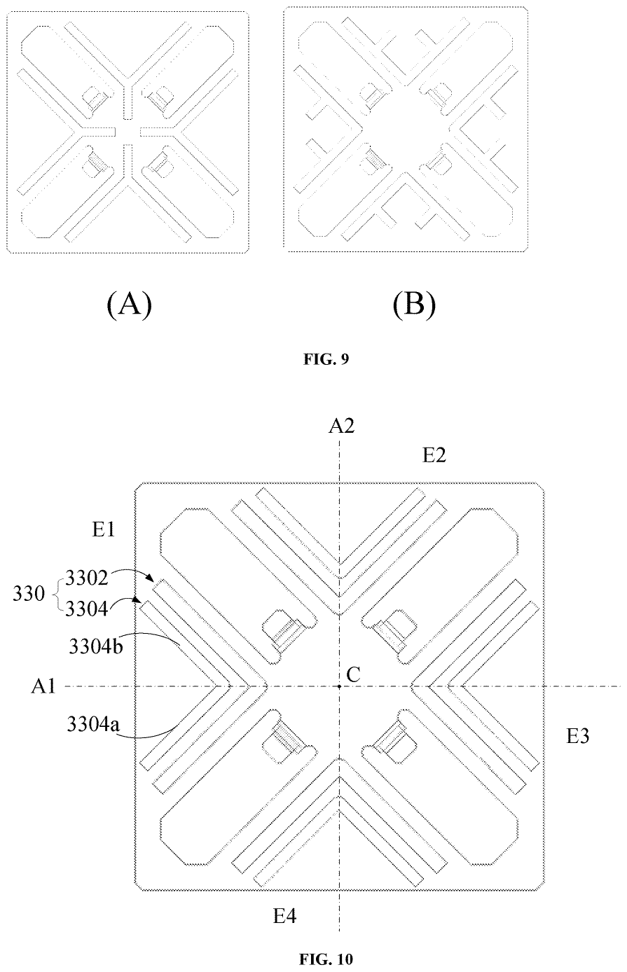

In some embodiments, referring to FIG. 8, patch radiating elements are provided that include slots 230 that have a first slot portion 230a located on a first side of a respective axis A1 (A2) and a second slot portion 230b located on a second side opposite the first side of the respective axis A1 (A2), the second slot portion 230b merging into and thus being connected with the first slot portion 230a. FIG. 9 further illustrates a variety of additional patch radiating elements having other example slot configurations, where the slots include first and second slot portions that are connected to each other at respective sides of and angled to respective axes, wherein the slots in (A) have small branches at locations proximate to the center, and the slots in (B) have small branches at intermediate locations between the respective edges and the center.

In some examples, the slots 130 may include a plurality of slot portions that are not connected to one another, wherein each slot portion extends from a respective first position on the patch radiator 120 to a respective second position on the patch radiator 120 that is adjacent a respective edge of the patch radiator 120 that is adjacent to a center of the patch radiator 120. Each of these slot portions may have a design for the slot described previously with respect to the FIGS. 2-9 and the like. For example, these slot portions may each have one or more geometric lengths, and wherein at least the maximum geometric length is between 0.1 to 0.5 times the operating wavelength of the patch radiator 120. The geometric lengths of these slot portions may be the same as each other or may be different from each other. Where the geometric lengths of these slots are different from each other, a variety of different resonating lengths may be provided, thereby increasing the resonating bandwidth. These slot portions may also have one or more branches in order to provide a variety of different resonant lengths, thereby increasing the resonant bandwidth, and may also be used to fine-tune impedance matching to increase matching bandwidth and decrease Q value. These slot portions may be symmetrical with respect to a respective axis that passes through the center of the patch radiator 120 and perpendicular to a respective edge of the patch radiator 120, or may have axis symmetry with respect to that respective axis as a whole. Such symmetry may facilitate both first and second polarization for dual-polarized patch radiating elements.

For example, referring to FIG. 10, a patch radiating element is shown that includes slot 330s that include a plurality of slot portions 3302, 3304 that are not connected to one another, wherein each slot portion extends from a respective first position on the patch radiator 120 to a respective second position on the patch radiator 120 adjacent a respective edge E1 (E2, E3, E4) of the patch radiator 120, which is adjacent to a center C of the patch radiator 120. In some examples, each slot portion 3302, 3304 includes a first segment 3304a located on a first side of a respective axis A1 (A2) and a second segment 3304b located on a second side opposite the first side of the respective axis A1 (A2), wherein the second segment 3304b is connected to the first segment 3304a. Each slot portion 3302, 3304 is symmetrical about a respective axis A1 (A2) and the slot 330 as a whole has axis symmetry about a respective axis A1 (A2).

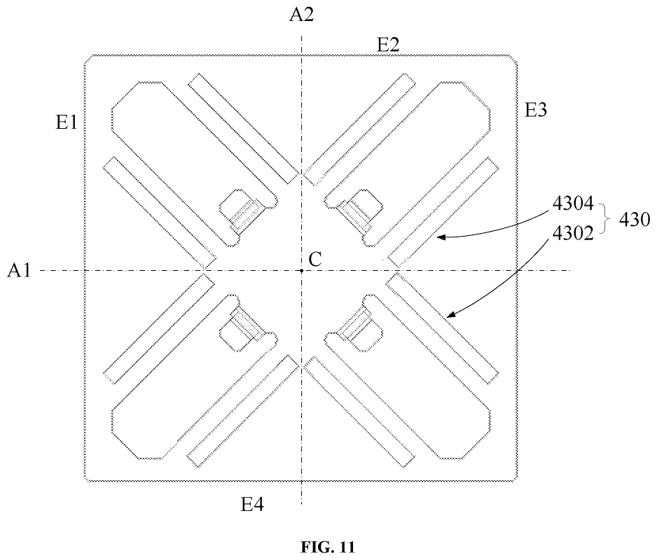

Referring to FIG. 11, a patch radiating element is shown that includes slots 430 that have a plurality of slot portions 4302, 4304 that are not connected to one another, wherein each slot portion extends from a respective first position on the patch radiator 120 to a respective second position on the patch radiator 120 adjacent a respective edge E1 (E2, E3, E4) of the patch radiator 120, which is adjacent to a center C of the patch radiator 120. The slot portion 4302 is located on a first side of a respective axis A1 (A2) and the slot portion 4304 is located on a second side of the respective axis A1 (A2) opposite the first side. The slots 430 generally have axis symmetry with respect to a respective axis A1 (A2).

Regardless of whether each slot 130 has a “integrated” design as shown in FIGS. 2-9 or a “fragmented” design as shown in FIGS. 10-11, with the plurality of slots 130 disposed on the patch radiator 120, in some examples, the plurality of slots 130 as a whole may have rotational symmetry with respect to the center C of the patch radiator 120, which may be advantageous to improve the radiation pattern. For the dual-polarized patch radiating element, in some examples, each of the plurality of slots 130 is symmetrical with respect to the first and second adjacent slots 130 and with respect to the second feeding directions, which may facilitate achieving a high CPR in both polarized directions.

In some examples, the patch radiator may include a first patch portion and a second patch portion positioned at an edge of the first patch portion and extending rearwardly from the first patch portion, wherein the slot is disposed on the first patch portion. Such a curved design facilitates reducing the size of the patch radiating element and facilitates the placement of the patch radiating element array in the antenna.

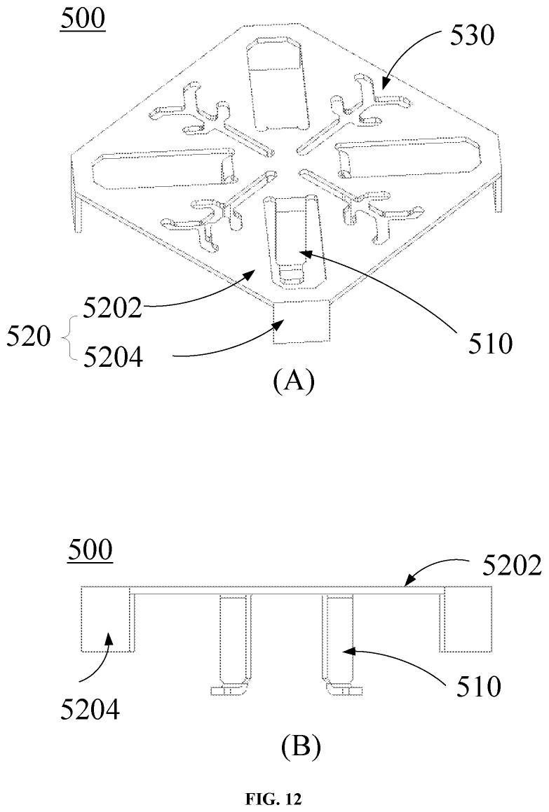

FIG. 12 shows the patch radiating element 500 which is another modified version of the patch radiating element 100. The radiating element 500 includes a plurality of feeder pillars 510 and a patch radiator 520 positioned at a front end of the feeder pillars 510. The patch radiator 520 includes four first patch portions 5202 and four second patch portions 5204, with each second patch portion 5204 positioned at an edge of a respective one of the first patch portions 5202 and extending rearwardly from the respective first patch portion 5202. A respective slot 530 is disposed on each first patch portion 5202. In the example of FIG. 12, the four second patch portions 5204 are each bent at a right angle from the respective first patch portion 5202.

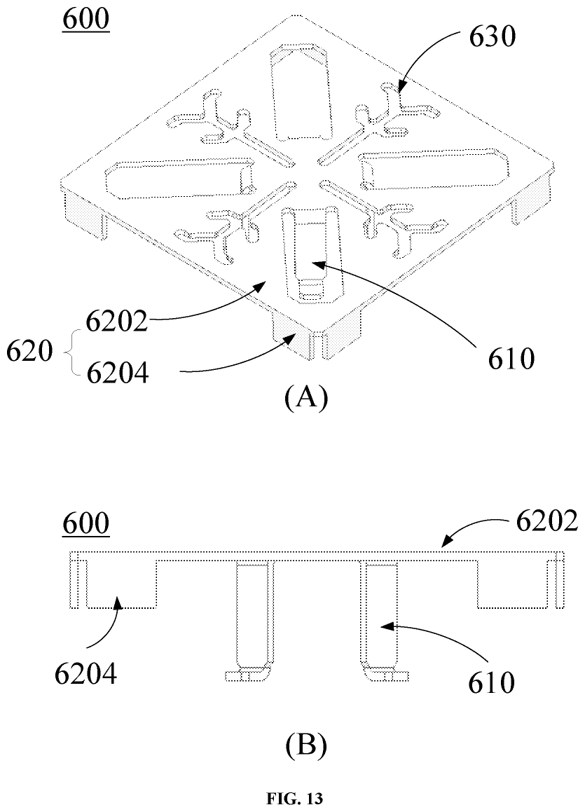

FIG. 13 shows the patch radiating element 600 as another modified version of the patch radiating element 100. The patch radiating element 600 includes a plurality of feeder pillars 610 and a patch radiator 620 positioned at a front end of the feeder pillars 610. The patch radiator 620 includes four first patch portions 6202 and eight second patch portions 6204, with each second patch portion 6204 positioned at an edge of a respective one of the first patch portions 6202 and extending rearwardly from the respective first patch portion 6202. A respective slot 630 is disposed on each first patch portion 6202. In the example of FIG. 13, a respective second patch portion 6204 is bent therefrom at each end of the edge of each first patch portion 6202.

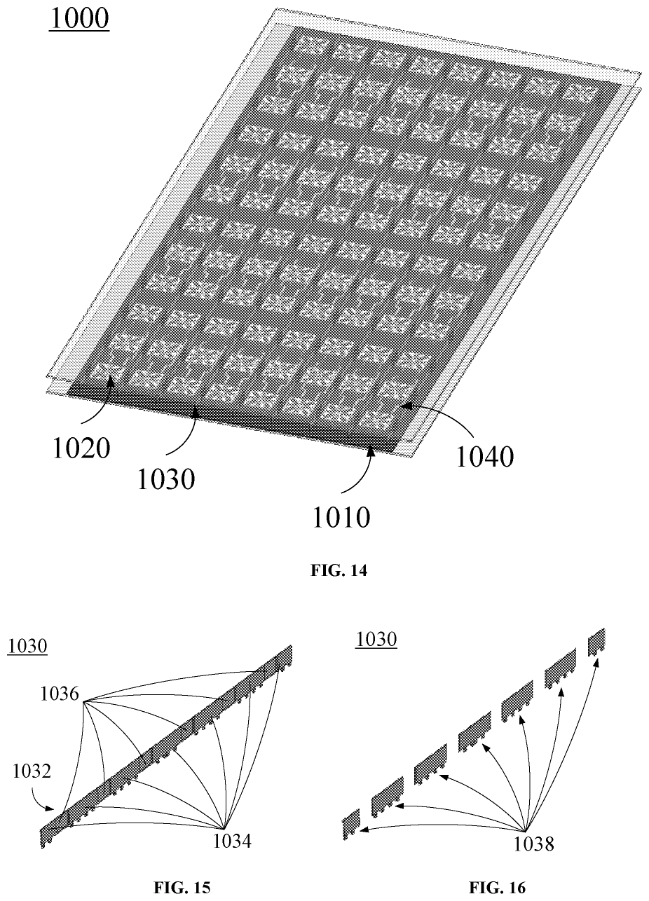

The present disclosure also provides a base station antenna, which may include a patch radiating element as described in accordance with any one of the examples of the present disclosure. For example, referring to FIG. 14, the base station antenna 1000 includes a reflector 1010 and a plurality of radiating elements 1020 that are mounted on and extending forwardly from the reflector 1010. The radiating element 1020 may be patch radiating elements according to any one of the examples of the present disclosure. In particular, in some examples, the feed plate is typically disposed on the front surface of the reflector 1010 and the feed plate forms a matching network 1040 from which the feeder pillars of the radiating elements 1020 may electrically connect (e.g., by welding) with the matching network 1040 to obtain the RF signal.

As shown in FIG. 14, the base station antenna 1000 may include an array of radiating elements 1020. In some examples, the base station antenna 1000 may further comprise a plurality of fences 1030 mounted on and extending forwardly from the reflector 1010, each of the fences 1030 arranged in a first direction parallel to a column in the array such that each column of the array is located between two adjacent fences 1030 in the plurality of fences 1030. Each of the fences 1030 may include a plurality of metal portions arranged spaced apart from each other along a first direction. The fences 1030 may be used as a radiation boundary. Traditional fences are arranged between the columns of the array and between the rows of the array. However, with the fences 1030, it is only desirable to be arranged between the columns of the array without having to be arranged between the rows of the array, which is advantageous to reduce costs. By adjusting the height of the fences 1030 (i.e., the distance extending forward from the reflector 1010) and/or the size of the gap between the metal portions, the CPR can be optimized, such as to improve the CPR to better than 20 dB.

In some examples, each radiating element 1020 overlaps a gap between a respective two metal portions of a plurality of metal portions of each fence 1030 in a second direction parallel to the rows in the array. In some examples, each metallic portion of each fence 1030 overlaps a respective gap between two of the plurality of radiating elements 1020 in each column, seen in a second direction parallel to the rows in the array.

Referring to FIG. 15, in some examples, each fence 1030 includes a printed circuit board 1032, a plurality of metal portions 1034 formed from metal deposited on the printed circuit board 1032. The printed circuit board 1032 has no metal at a gap 1036 between each adjacent two metal portions 1034 of the plurality of metal portions 1034. In such examples, the gap between the metal portions may include the portion of the substrate of the printed circuit board 1032.

Referring to FIG. 16, in some further examples, each fence 1030 includes a plurality of metal sheets 1038 arranged spaced apart from each other along a first direction, each metal portion of the plurality of metal portions being formed by a respective one of the plurality of metal sheets 1038. In such examples, the gap between the metal portions may include air.

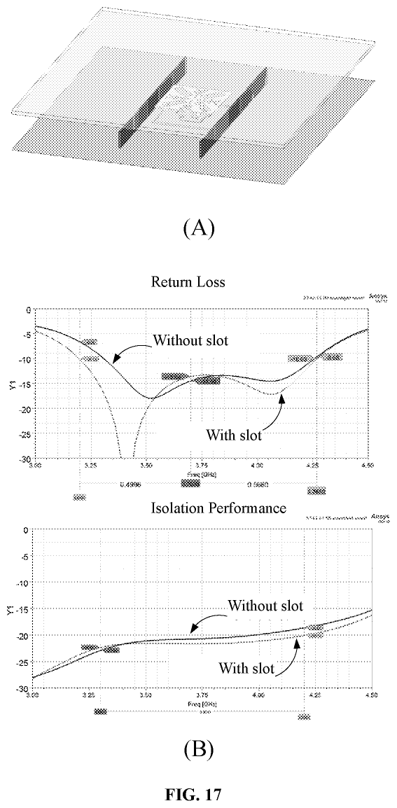

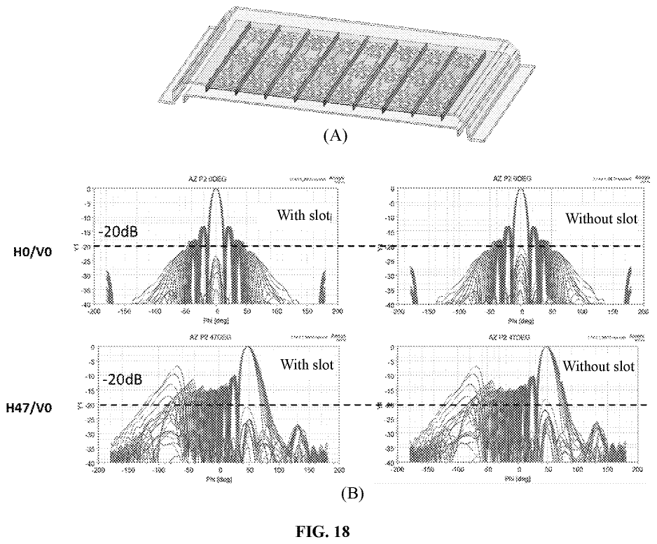

FIGS. 17-18 show some performance comparison results obtained by simulation.

The (A) of FIG. 17 illustrates a simulation environment comprising a single patch radiating element located between two fences. The (B) of FIG. 17 illustrates that the RL matching relative bandwidth expanded from 25.1% to 29.1% and isolation also improved by 1.5 dB with the slot compared to the absence of a slot.

The (A) of FIG. 18 illustrates a simulation environment including a plurality of columns of patch radiating elements located between a plurality of fences. FIG. 18 (B) shows that the CPR improved by 2.6 dB at azimuth 0°/upset 0° (H0/V0) and improved by 3 dB at azimuth 47°/upside 0° (H47/V0), compared to the absence of a slot, with the slot. This high CPR performance is advantageous for large-scale MIMO systems.

The terms “left”, “right”, “front”, “rear”, “top”, “bottom”, “upper”, “lower”, “high”, “low” in the Specification and Claims, if present, are used for descriptive purposes and not necessarily used to describe constant relative positions. It should be understood that the terms used in this way are interchangeable under appropriate circumstances, so that the examples of the present disclosure described herein, for example, can operate on other orientations that differ from those orientations shown herein or otherwise described. For example, when the device in the attached drawing is turned upside down, features that were originally described as “above” other features can now be described as “below” other features. The device may also be oriented by other means (rotated by 90 degrees or at other locations), and at this time, a relative spatial relation will be explained accordingly.

In the Specification and the Claims, when an element is referred to as being “above” another element, “attached” to another element, “connected” to another element, “coupled” to another element, or “in contact with” another element, the element may be directly above another element, directly attached to another element, directly connected to another element, directly coupled to another element, or directly in contact with another element, or there may be one or a plurality of intermediate elements. In contrast, if an element is described as “directly” “above” another element, “directly attached” to another element, “directly connected” to another element, “directly coupled” to another element or “directly in contact with” another element, there will be no intermediate elements. In the Specification and Claims, a feature that is arranged “adjacent” to another feature, may denote that a feature has a part that overlaps an adjacent feature or a part positioned above or below the adjacent feature.

As used herein, the word “exemplary” means “serving as an example, instance, or illustration” rather than as a “model” to be copied exactly. Any realization method described exemplarily herein is not necessarily interpreted as being preferable or advantageous over other realization methods. Moreover, the present disclosure is not limited by any expressed or implied theory given in the technical field, background art, summary of the invention, or specific implementation methods.

As used herein, the word “substantially” means comprising any minor changes caused by design or manufacturing defects, device or component tolerances, environmental influences, and/or other factors. The word “substantially” also allows the gap from the perfect or ideal situation due to parasitic effects, noise, and other practical considerations that may be present in the actual realization.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

It should also be understood that when the term “include/comprise” is used in this text, it indicates the presence of the specified feature, entirety, step, operation, cell and/or component, but does not exclude the presence or addition of one or more other features, entireties, steps, operations, cells and/or components and/or combinations thereof. In the present disclosure, the term “provide” is used in a broad sense to cover all ways of obtaining an object, so “providing an object” comprises but is not limited to “purchase”, “preparation/manufacturing”, “arrangement/setting”, “installation/assembly”, and/or “order” of the object, etc.

As used herein, the term “and/or” comprises any and all combinations of one or more of the associated listed items. The terms used herein are only for the purpose of describing specific examples and are not intended to limit the present disclosure. As used herein, the singular forms “a”, “an” and “the” are also intended to include the plural forms, unless the context clearly dictates otherwise.

The same or similar portions among various examples of the present disclosure are recited to each other, with each example focusing on differences from other examples. Throughout the description of the present disclosure, reference to the terms “one example,” “some examples,” “examples,” “specific examples,” or “some examples,” “exemplary” and other descriptions means that specific features, structures, materials, or characteristics described in connection with the example or examples are included in at least one example or example of the present disclosure. In the present disclosure, the illustrative expression of the above terms must not be directed to the same examples or examples. Moreover, the specific features, structures, materials, or characteristics described may be combined in a suitable manner in any one or more examples or examples. Moreover, without contradiction, those skilled in the art may incorporate and combine different examples or examples described in the present disclosure, as well as the features of the different examples or examples.

In addition, when used in the present disclosure, the words “here,” “above,” “below,” “herein,” “below,” “above,” and similar meanings shall refer to the present disclosure as a whole and not to any particular part of the present disclosure. Further, unless expressly stated otherwise or otherwise understood in the context used, conditional language used herein, such as “can,” “may,” “e.g.,” “such as,” and the like, is generally intended to express that certain examples comprise certain features, elements, and/or states while other examples do not comprise them. Accordingly, such conditional language is not generally intended to imply that one or more examples require features, elements, and/or states in any way, or whether these features, elements, and/or states are included or certain features, elements, and/or states are performed in any particular example.

Those skilled in the art should realize that the boundaries between the above operations are merely illustrative. A plurality of operations can be combined into a single operation, which may be distributed in the additional operation, and the operations can be executed at least partially overlapping in time. Also, alternative examples may include a plurality of instances of specific operations, and the order of operations may be changed in other various examples. However, other modifications, changes and substitutions are also possible. Aspects and elements of all examples disclosed above may be combined in any manner and/or in conjunction with aspects or elements of other examples to provide a plurality of additional examples. Therefore, the Specification and attached drawings hereof should be regarded as illustrative rather than limitative.

Although some specific examples of the present disclosure have been described in detail through examples, those skilled in the art should understand that the above examples are only for illustration rather than for limiting the scope of the present disclosure. The examples disclosed herein can be combined arbitrarily without departing from the spirit and scope of the present disclosure. Those skilled in the art should also understand that various modifications may be made to the examples without departing from the scope and spirit of the present disclosure. The scope of the present disclosure is defined by the attached claims.

1. A patch radiating element, comprising:
a feeder pillar; and
a patch radiator positioned at a front end of the feeder pillar, the patch radiator including a plurality of slots,
wherein the plurality of slots are configured such that when the patch radiator is fed a radio frequency (“RF”) signal via the feeder pillar, the current in a central area of the patch radiator is increased as compared to when the patch radiator does not include the plurality of slots.

2. The patch radiating element of claim 1, wherein the patch radiator includes first and second feed points for a first polarized RF signal and third and fourth feed points for a second polarized RF signal,
wherein the plurality of slots are configured such that:
a current flowing along a first feed direction is generated in the central area of the patch radiator when the patch radiator is fed an RF signal via the first and second feed points, the first feed direction being defined by the first and second feed points; or
a current flowing along a second feed direction is generated in the central area of the patch radiator when the patch radiator is fed an RF signal via the third and fourth feed points, the second feed direction being defined by the third and fourth feed points.

3. The patch radiating element of claim 1, wherein each of the plurality of slots has one or more geometric lengths, and wherein:
a maximum geometric length of the one or more geometric lengths is between 0.1 and 0.5 times the operating wavelength of the patch radiator; or
the one or more geometric lengths are each between 0.1 and 0.5 times the operating wavelength of the patch radiator.

4. (canceled)

5. The patch radiating element of claim 1, wherein each of the plurality of slots extends from a first position on the patch radiator to a second position on the patch radiator, the first position being adjacent a respective edge of the patch radiator, the second position being adjacent a center of the patch radiator.

6. The patch radiating element of claim 5, wherein each of the plurality of slots is symmetrical with respect to a respective axis passing through the center of the patch radiator and perpendicular to the respective edge of the patch radiator.

7. The patch radiating element of claim 5, wherein each of the plurality of slots includes a first slot portion that extends along a respective axis that passes through the center of the patch radiator and is perpendicular to the respective edge of the patch radiator.

8. The patch radiating element of claim 7, wherein each of the plurality of slots includes a second slot portion extending at an angle to the respective axis and connected with the first slot portion.

9. The patch radiating element of claim 8, wherein the second slot portion is perpendicular to the respective axis and is closer to the respective edge of the patch radiator than a center of the patch radiator.

10. (canceled)

11. The patch radiating element of claim 1, wherein each of the plurality of slots includes a plurality of slot portions that are not connected to one another, each of the plurality of slot portions extending from a respective first position on the patch radiator to a respective second position on the patch radiator, the respective first position being adjacent a respective edge of the patch radiator, and the respective second position being adjacent a center of the patch radiator.

12. The patch radiating element according to claim 11, wherein
each of the plurality of slot portions has one or more geometric lengths, at least a maximum geometric length of the one or more geometric lengths being between 0.1 and 0.5 times the operating wavelength of the patch radiator; or
the plurality of slot portions have different geometric lengths from one another; or
each of the plurality of slot portions has one or more branches; or
each slot portion of the plurality of slot portions is symmetrical with respect to a respective axis passing through the center of the patch radiator and perpendicular to the respective edge of the patch radiator; or
the plurality of slot portions as a whole have axial symmetry with respect to the respective axis; or
each slot portion of the plurality of slot portions comprises a first segment located on a first side of the respective axis and a second segment located on a second side of the respective axis opposite the first side, the second segment being connected with the first segment; or
the plurality of slot portions includes a first slot portion located on a first side of the respective axis and a second slot portion located on a second side opposite the first side of the respective axis, the second slot portion being not connected with the first slot portion.

13. (canceled)

14. The patch radiating element of claim 1, wherein the plurality of slots generally have rotational symmetry with respect to a center of the patch radiator.

15. (canceled)

16. The patch radiating element of claim 1, wherein the patch radiator comprises a first patch portion and a second patch portion positioned at an edge of the first patch portion and extending rearwardly from the first patch portion, wherein the plurality of slots are disposed on the first patch portion.

17. A patch radiating element, including:
a feeder pillar; and
a patch radiator positioned at a front end of the feeder pillar, a slot disposed on the patch radiator, the slot extending from a first position on the patch radiator to a second position on the patch radiator, the first position being adjacent an edge of the patch radiator, the second position being adjacent a center of the patch radiator.

18. The patch radiating element of claim 17, wherein the slot has one or more geometric lengths, and wherein:
a maximum geometric length of the one or more geometric lengths is between 0.1 and 0.5 times the operating wavelength of the patch radiator; or
the one or more geometric lengths are each between 0.1 and 0.5 times the operating wavelength of the patch radiator.

19. The patch radiating element of claim 17, wherein the slot has one or more branches.

20. The patch radiating element of claim 17, wherein the slot is symmetrical with respect to an axis passing through the center of the patch radiator and perpendicular to the edge of the patch radiator.

21. The patch radiating element of claim 17, wherein the slot includes a first slot portion extending along an axis that passes through the center of the patch radiator and is perpendicular to the edge of the patch radiator.

22. (canceled)

23. The patch radiating element of claim 17, wherein the slot includes a first slot portion located on a first side of an axis that passes through the center of the patch radiator and perpendicular to the edge of the patch radiator and a second slot portion located on a second side of the axis opposite the first side, the second slot portion being connected with the first slot portion.

24. The patch radiating element of claim 17, wherein the slot includes a plurality of slot portions that are not connected to one another, each slot portion of the plurality of slot portions extending from a respective first position on the patch radiator to a respective second position on the patch radiator, the respective first position being adjacent the edge of the patch radiator, the respective second position being adjacent the center of the patch radiator.

25. The patch radiating element according to claim 24, wherein
each of the plurality of slot portions has one or more geometric lengths, at least a maximum geometric length of the one or more geometric lengths being between 0.1 and 0.5 times the operating wavelength of the patch radiator; or
the plurality of slot portions have different geometric lengths from one another; or
each of the plurality of slot portions has one or more branches; or
each slot portion of the plurality of slot portions is symmetrical with respect to an axis passing through the center of the patch radiator and perpendicular to the edge of the patch radiator; or
the plurality of slot portions as a whole have axial symmetry with respect to the axis; or
each slot portion of the plurality of slot portions includes a first segment located on a first side of the axis and a second segment located on a second side of the axis opposite the first side, the second segment being connected with the first segment; or
the plurality of slot portions include a first slot portion located on a first side of the axis and a second slot portion located on a second side of the axis opposite the first side, the second slot portion being not connected with the first slot portion.

26-30. (canceled)
